(19) United States
(12) Patent Application Publication
(10) Pub. No.: US 2011/0154197 A1
(43) Pub. Date: Jun. 23, 2011

(54) System and method for algorithmic movie generation based on audio/video synchronization

(76) Inventors: Louis Hawthorne, Mill Valley, CA (US); d'Armond Lee Speers, Thornton, CO (US); Michael Renn Neal, Arvada, CO (US); Abigail Betsy Wright, Longmont, CO (US); Spencer Stuart McCall, San Francisco, CA (US)

(21) Appl. No.: 12/642,135

(22) Filed: Dec. 18, 2009

(51) Int. Cl. G06F 3/00

(52) U.S. Cl. 715/704

(57) ABSTRACT

A new approach is proposed that contemplates systems and methods to combine highly targeted and customized content items with algorithmic filmmaking techniques to create a film-quality, personalized multimedia experience (MME)/movie for a user. First, a rich content database is created and embellished with meaningful, accurate, and properly organized multimedia content items tagged with meta-information. Second, a software agent interacts with the user to create, learn, and exploit the user's context to determine which content items need to be retrieved and how they should be customized in order to create a script of content to meet the user's current need. Finally, retrieved and/or customized multimedia content items such as text, images, or video clips are utilized to create a script of movie-like content using automatic filmmaking techniques such as audio synchronization, image control and manipulation, and appropriately customized dialog and content.

### RELATED APPLICATIONS

This application is related to U.S. patent application Ser. No. 12/460,522 filed Jul. 20, 2009, and entitled “A system and method for identifying and providing user-specific psychoactive content,” by Hawthorne et al., and is hereby incorporated herein by reference.

### BACKGROUND

With the growing volume of content available over the Internet, people are increasingly seeking content online for useful information to address their problems as well as for a meaningful emotional and/or psychological experience. A multimedia experience (MME) is a movie-like presentation of a script of content created for and presented to an online user, preferably based on his/her current context. Here, the content may include one or more content items of a text, an image, a video, or audio clip. The user's context may include the user's profile, characteristics, desires, his/her rating of content items, and history of the user's interactions with an online content vendor/system (e.g., the number of visits by the user).

Due to the multimedia nature of the content, it is often desirable for the online content vendor to simulate the qualities found in motion pictures in order to create “movie-like” content for the user to enjoy an MME with content items including music, text, images, and videos as a backdrop. While creating simple Adobe Flash files and making “movies” with minimal filmmaking techniques from a content database is straightforward, the utility of these movies when applied to a context of personal interaction is complex. To create a movie that emotionally connects with the user on a deeply personal, emotional, and psychological level or an advertising application that seeks to connect the user with other emotions, traditional and advanced filmmaking techniques/effects need to be developed and exploited. Such techniques include but are not limited to, transitions tied to image changes as a fade in or out, gently scrolling text and/or images to a defined point of interest, color transitions in imagery, and transitions on music changes in beat or tempo. While many users may not consciously notice these effects, these effects can be profound in creating a personal or emotional reaction by the user to the generated MME.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support algorithmic movie generation.

FIG. 2 illustrates an example of various information that may be included in a user's profile.

FIG. 3 depicts a flowchart of an example of a process to establish the user's profile.

FIG. 4 illustrates an example of various types of content items and the potential elements in each of them.

FIG. 5 depicts examples of sliders that can be used to set values of psychoactive tags on image items.

FIGS. 6(a)-(b) depict examples of adjustment points along a timeline of a content script template.

FIG. 7 depicts an example of adjusting the start time of a content item based on beat detection.

FIG. 8 depicts an example of rules-based synchronization based on tempo detection.

FIG. 9 depicts an example of adjustment of the item beginning transition to coincide with the duration of a measure.

FIG. 10 depicts an example of change of item transition time based on key change detection.

FIG. 11 depicts an example of rules-based synchronization based on dynamics change detection.

FIG. 12 depicts a flowchart of an example of a process to create an image progression in a movie based on psychoactive properties of the images.

FIG. 13 depicts a flowchart of an example of a process to support algorithmic movie generation.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to create a film-quality, personalized multimedia experience (MME)/movie composed of one or more highly targeted and customized content items using algorithmic filmmaking techniques. Here, each of the content items can be individually identified, retrieved, composed, and presented to a user online as part of the movie. First, a rich content database is created and embellished with meaningful, accurate, and properly organized multimedia content items tagged with meta-information. Second, a software agent interacts with the user to create, learn, and explore the user's context to determine which content items need to be retrieved and how they should be customized in order to create a script of content to meet the user's current need. Finally, the retrieved and/or customized multimedia content items such as text, images, or video clips are utilized by the software agent to create a script of movie-like content via automatic filmmaking techniques such as audio synchronization, image control and manipulation, and appropriately customized dialog and content. Additionally, one or more progressions of images can also be generated and inserted during creation of the movie-like content to effectuate an emotional state-change in the user. Under this approach, the audio and visual (images and videos) content items are the two key elements of the content, each having specific appeals to create a deep personal, emotional, and psychological experience for a user in need. Such experience can be amplified for the user with the use of filmmaking techniques so that the user can have an experience that helps him/her focus on interaction with the content instead of distractions he/she may encounter at the moment.

Such a personalized movie making approach has numerous potential commercial applications that include but are not limited to advertising, self-help, entertainment, and education. The capability to automatically create a movie from content items in a content database personalized to a user can also be used, for a non-limiting example, to generate video essays for a topic such as a news event or a short history lesson to replace the manual and less-compelling photo essays currently used on many Internet news sites.

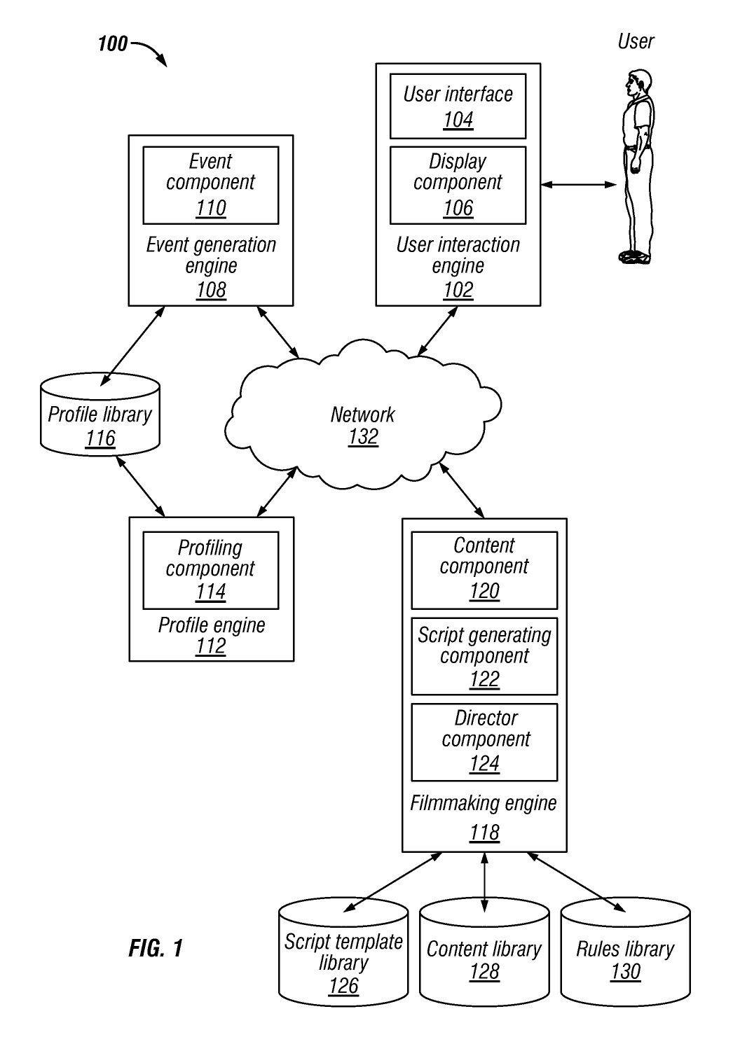

FIG. 1 depicts an example of a system diagram to support algorithmic movie generation. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a user interaction engine 102, which includes at least a user interface 104, and a display component 106; an event generation engine 108, which includes at least an event component 110; a profile engine 112, which includes at least a profiling component 114; a profile library (database) 116 coupled to the event generation engine 108 and the profile engine 112; a filmmaking engine 118, which includes at least a content component 120, a script generating engine 122, and a director component 124; a script template library (database) 126 a content library (database) 128, and a rules library (database) 130, all coupled to the filmmaking engine 118; and a network 132.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, an iPhone, a PDA, or a server machine. A storage device can be but is not limited to a hard disk drive, a flash memory drive, or any portable storage device. A communication device can be but is not limited to a mobile phone.

In the example of FIG. 1, the user interaction engine 102, the event generation engine 108, the profile engine 112, and the filmmaking engine 118 each has a communication interface (not shown), which is a software component that enables the engines to communicate with each other following certain communication protocols, such as TCP/IP protocol. The communication protocols between two devices are well known to those of skill in the art.

In the example of FIG. 1, the network 132 enables the user interaction engine 102, the event generation engine 108, the profile engine 112, and the filmmaking engine 118 to communicate and interact with each other. Here, the network 132 can be a communication network based on certain communication protocols, such as TCP/IP protocol. Such network can be but is not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, the user interaction engine 102 is configured to enable a user to submit a topic or situation to which the user intends to seek help or counseling or to have a related movie created via the user interface 104 and to present to the user a script of content relevant to addressing the topic or the movie request submitted by the user via the display component 106. Here, the topic (problem, question, interest, issue, event, condition, or concern, hereinafter referred to a topic) of the user provides the context for the content that is to be presented to him/her. The topic can be related to one or more of personal, emotional, psychological, relational, physical, practical, or any other need of the user. The creative situation can be derived from databases of specific content. For example, a wildlife conservation organization may create a specific database of images of wildlife and landscapes with motivational and conservation messages. In some embodiments, the user interface 104 can be a Web-based browser, which allows the user to access the system 100 remotely via the network 132.

In an alternate embodiment in the example of FIG. 1, the event generation engine 108 determines an event that is relevant to the user and/or the user's current context, wherein such event would trigger the generation of a movie by the filmmaking engine 118 even without an explicit inquiry from the user via the user interaction engine 102. Here, the triggering event can be but is not limited to a birthday, a tradition, or a holiday (such as Christmas, Ramadan, Easter, Yom Kippur). Such triggering event can be identified by the event component 110 of the event generation engine 108 based on a published calendar as well as information of the user's profile and history maintained in the profile library 116 discussed below.

In some embodiments, the event component 110 of the event generation engine 108 may be alerted by a news feed such as RSS to an event of interest to the user and may in turn inform the filmmaking engine 118 to create a movie or specific content in a movie for the user. The filmmaking engine 118 receives such notification from the event generation engine 108 whenever an event that might have an impact on the automatically generated movie occurs. For a non-limiting example, if the user is seeking wisdom and is strongly identified with a tradition, then the event component 110 may notify the filmmaking engine 118 of important observances such as Ramadan for a Muslim, wherein the filmmaking engine 118 may decide to use such information or not when composing a movie. For another non-limiting example, the most recent exciting win by a sports team of a university may trigger the event component 110 to provide notification to the filmmaking engine 118 to include relevant text, imagery or video clips of such win into a sports highlight movie of the university being specifically created for the user.

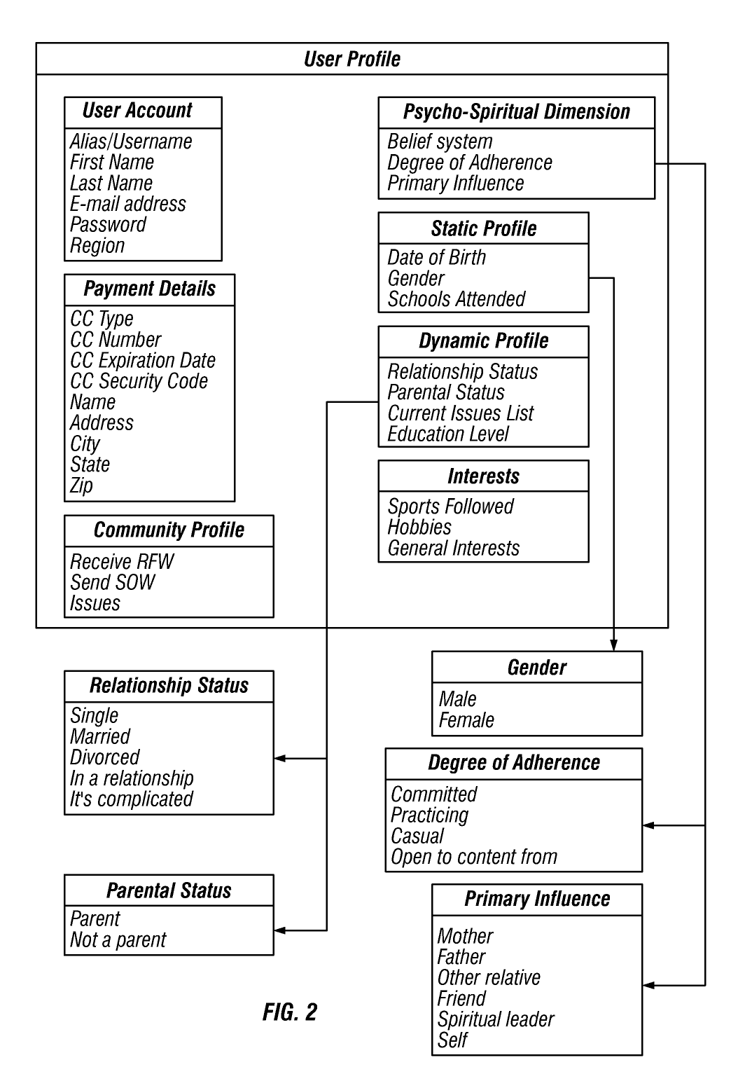

In the example of FIG. 1, the profile engine 112 establishes and maintains a profile of the user in the profile library 116 via the profiling component 114 for the purpose of identifying user-context for generating and customizing the content to be presented to the user. The profile may contain at least the following information of the user: gender and date of birth, parental status, marital status, universities attended, relationship status, as well as his/her current interests, hobbies, income level, habits; psycho-emotional information such as his/her current issues and concerns, psychological, emotional, and religious traditions, belief system, degree of adherence and influences; community information that defines how the user interacts with the online community of experts and professionals, and other information the user is willing to share. FIG. 2 illustrates an example of various information that may be included in a user profile.

In some embodiments, the profile engine 112 may establish the profile of the user by initiating one or more questions during pseudo-conversational interactions with the user via the user interaction engine 102 for the purpose of soliciting and gathering at least part of the information for the user profile listed above. Here, such questions focus on the aspects of the user's life that are not available through other means. The questions initiated by the profile engine 112 may focus on the personal interests or the emotional and/or psychological dimensions as well as dynamic and community profiles of the user. For a non-limiting example, the questions may focus on the user's personal interest, which may not be truly obtained by simply observing the user's purchasing habits.

In some embodiments, the profile engine 112 updates the profile of the user via the profiling component 114 based on the prior history/record of content viewing and dates of one or more of:
topics that have been raised by the user;
relevant content that has been presented to the user;
script templates that have been used to generate and present the content to the user;
feedback from the user and other users about the content that has been presented to the user.

In the example of FIG. 1, the profile library 116 embedded in a computer readable medium, which in operation, maintains a set of user profiles of the users. Once the content has been generated and presented to a user, the profile of the user stored in the profile library 116 can be updated to include the topic submitted by the user as well as the content presented to him/her as part of the user history. If the user optionally provides feedback on the content, the profile of the user can also be updated to include the user's feedback on the content.

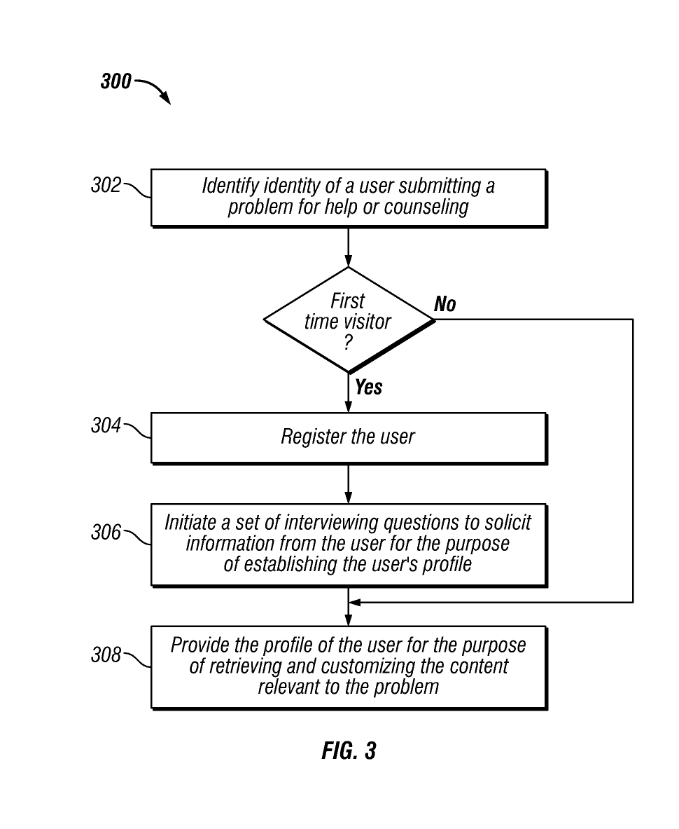

FIG. 3 depicts a flowchart of an example of a process to establish the user's profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where identity of the user submitting a topic for help or counseling is established. If the user is a first time visitor, the flowchart 300 continues to block 304 where the user is registered, and the flowchart 300 continues to block 306 where a set of interview questions are initiated to solicit information from the user for the purpose of establishing the user's profile. The flowchart 300 ends at block 308 where the profile of the user is provided to the filmmaking engine 118 for the purpose of retrieving and customizing the content relevant to the topic.

In the example of FIG. 1, the content library 128, serving as a media “book shelf”, maintains a collection of multimedia content items as well as definitions, tags, resources, and presentation scripts of the content items. The content items are appropriately tagged, categorized, and organized in a content library 128 in a richly described taxonomy with numerous tags and properties by the content component 120 of the filmmaking engine 118 to enable access and browsing of the content library 128 in order to make intelligent and context-aware selections. For a non-limiting example, the content items in the content library 128 can be organized by a flexible emotional and/or psychological-orientated taxonomy for classification and identification, including terms such as Christianity, Islam, Hinduism, Buddhism, and secular beliefs. The content items can also be tagged with an issue such as relationship breakup, job loss, death, or depression. Note that the tagging of traditions and issues are not mutually exclusive. There may also be additional tags for additional filtering such as gender and humor.

Here, each content item in the content library 128 can be, but is not limited to, a media type of a (displayed or spoken) text (for non-limiting examples, an article, a short text item for quote, a contemplative text such as a personal story or essay, a historical reference, sports statistics, a book passage, or a medium reading or longer quote), a still or moving image (for a non-limiting example, component imagery capable of inducing a shift in the emotional state of the viewer), a video clip (including clips from videos that can be integrated into or shown as part of the movie), an audio clip (for a non-limiting example, a piece of music or sounds from nature or a university sports song), and other types of content items from which a user can learn information or be emotionally impacted, ranging from five thousand years of sacred scripts and emotional and/or psychological texts to modern self-help and non-religious content such as rational thought and secular content. Here, each content item can be provided by another party or created or uploaded by the user him/herself.

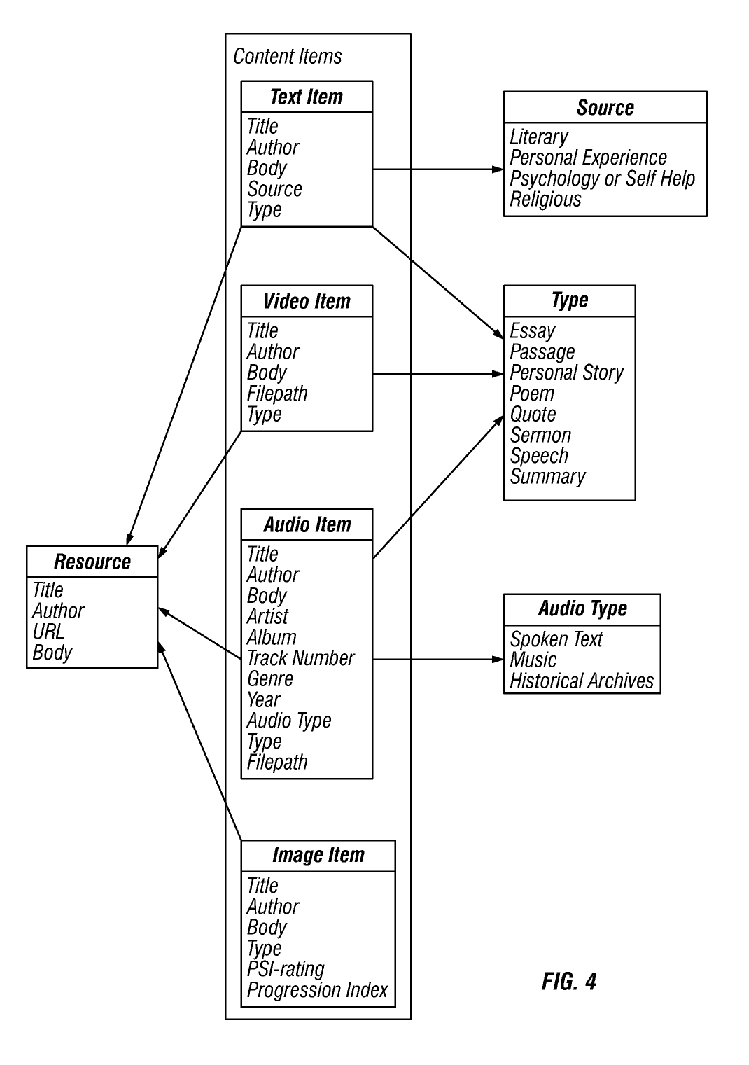

In some embodiments, each of a text, image, video, and audio item can include one or more elements of: title, author (name, unknown, or anonymous), body (the actual item), source, type, and location. For a non-limiting example, a text item can include a source element of one of literary, personal experience, psychology, self help, and religious, and a type element of one of essay, passage, personal story, poem, quote, sermon, speech, historical event description, sports statistic, and summary. For another non-limiting example, a video, an audio, and an image item can all include a location element that points to the location (e.g., file path or URL) or access method of the video, audio, or image item. In addition, an audio item may also include elements on album, genre, musician, or track number of the audio item as well as its audio type (music or spoken word). FIG. 4 illustrates an example of various types of content items and the potential elements in each of them.

In some embodiments, a text item can be used for displaying quotes, which are generally short extracts from a longer text or a short text such as an observation someone has made. Non-limiting examples include Gandhi: “Be the change you wish to see in the world,” and/or extracts from scared texts such as the Books of Psalms from the Bible. Quotes can be displayed in a multimedia movie for a short period of time to allow contemplation, comfort, or stimulation. For a non-limiting example, statistics from American Football on Super Bowls can be displayed while a user is watching compilation of sporting highlights for his or her favorite team.

In some embodiments, a text item can be used in a long format for contemplation or assuming a voice for communication with the user to, non-limiting examples, explain or instruct a practice. Here, long format represents more information (e.g., exceeding 200 words) than can be delivered on a single screen when the multimedia movie is in motion. Examples of long format text include but are not limited to personal essays on a topic or the description of or instructions for an activity such as a mediation or yoga practice.

In some embodiments, a text item can be used to create a conversational text (e.g., a script dialog) between the user and the director component 124. The dialog can be used with meta-tags to insert personal, situation-related, or time-based information into the movie. For non-limiting examples, a dialog can include a simple greeting with the user's name (e.g., Hello Mike, Welcome Back to the System), a happy holiday message for a specific holiday related to a user's spiritual or religious tradition (e.g., Happy Hanukah), or recognition of a particular situation of the user (e.g., sorry your brother is ill).

In some embodiments, an audio item can include music, sound effects, or spoken word. For a non-limiting example, an entire song can be used as the soundtrack for shorter movie. The sound effects may include items such as nature sounds, water, and special effects audio support tracks such as breaking glass or machine sounds. Spoken word may include speeches, audio books (entire or passages), and spoken quotes.

In some embodiments, image items in the content library 128 can be characterized and tagged, either manually or automatically, with a number of psychoactive properties (“Ψ-tags”) for their inherent characteristics that are known, or presumed, to affect the emotional state of the viewer. Here, the term “Ψ-tag” is an abbreviated form of “psychoactive tag,” since it is psychologically active, i.e., pertinent for association between tag values and psychological properties. These Ψ-tagged image items can be subsequently used to create emotional responses or connections with the user via a meaningful image progression as discussed later. These psychoactive properties mostly depend on the visual qualities of an image rather than its content qualities. Here, the visual qualities may include but are not limited to Color (e.g., Cool-to-Warm), Energy, Abstraction, Luminance, Lushness, Moisture, Urbanity, Density, and Degree of Order, while the content qualities may include but are not limited to Age, Altitude, Vitality, Season and Time of Day. For a non-limiting example, images may contain energy or calmness. When a movie is meant to lead to calmness and tranquility, imagery can be selected and transition with the audio or music track. Likewise, if an inspirational movie is made to show athletes preparing for the winter Olympics, imagery of excellent performances, teamwork, and success are important. Thus, the content component 120 may tag a night image from a city with automobile lights forming patterns across the entire image and a sunset image over a dessert scene with flowing sand and subtle differences in color and light differently. Note that dominant colors can be part of image assessment and analysis as color transitions can provide soothing or sharply contrasting reactions depending on the requirements of the movie.

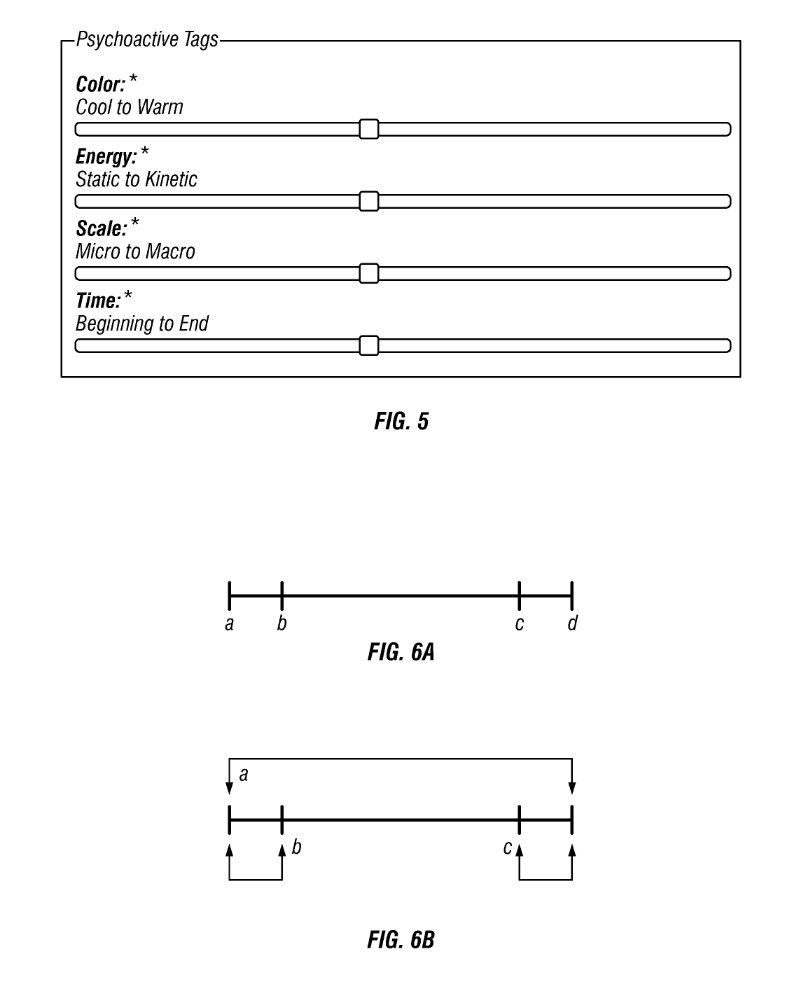

In some embodiments, numerical values of the psychoactive properties can be assigned to a range of emotional issues as well as a user's current context and emotional state gathered and known by the content component 120. These properties can be tagged along numerical scales that measure the degree or intensity of the quality being measured. FIG. 5 depicts examples of sliders that can be used to set values of the psychoactive tags on the image items.

In some embodiments, the content component 120 of the filmmaking engine 118 associates each content item in the content library 128 with one or more tags for the purpose of easy identification, organization, retrieval, and customization. The assignment of tags/meta data and definition of fields for descriptive elements provides flexibility at implementation for the director component 124. For a non-limiting example, a content item can be tagged as generic (default value assigned) or humorous (which should be used only when humor is appropriate). For another non-limiting example, a particular nature image may be tagged for all traditions and multiple issues. For yet another non-limiting example, a pair of (sports preference, country) can be used to tag a content item as football preferred for Italians. Thus, the content component 120 will only retrieve a content item for the user where the tag of the content item matches the user's profile.

In some embodiments, the content component 120 of the filmmaking engine 118 may tag and organize the content items in content library 128 using a content management system (CMS) with meta-tags and customized vocabularies. The content component 120 may utilize the CMS terms and vocabularies to create its own meta-tags for content items and define content items through these meta-tags so that it may perform instant addition, deletion, or modification of tags. For a non-limiting example, the content component 120 may add a Dominant Color tag to an image when it was discovered during research of MME the dominant color of an image was important for smooth transitions between images.

Once the content items in the content library 128 are tagged, the content component 120 of the filmmaking engine 118 may browse and retrieve the content items by one or more of topics, types of content items, dates collected, and by certain categories such as belief systems to build the content based on the user's profile and/or understanding of the items' “connections” with a topic or movie request submitted by the user. The user's history of prior visits and/or community ratings may also be used as a filter to provide final selection of content items. For a non-limiting example, a sample music clip might be selected to be included in the content because it was encoded for a user who prefers motivational music in the morning. The content component 120 may retrieve content items either from the content library 128 or, in case the content items relevant are not available there, identify the content items with the appropriate properties over the Web and save them in the content library 128 so that these content items will be readily available for future use.

In some embodiments, the content component 120 of the filmmaking engine 118 may retrieve and customize the content based on the user's profile or context in order to create personalized content tailored for the user's current need or request. A content item can be selected based on many criteria including the ratings of the content item from users with profiles similar to the current user, recurrence (how long ago, if ever, did the user see this item), how similar is this item to other items the user has previously rated, and how well does the item fit the issue or purpose of the movie. For a non-limiting example, content items that did not appeal to the user in the past based on his/her feedback will likely be excluded. In some situations when the user is not sure what he/she is looking for, the user may simply choose “Get me through the day” from the topic list and the content component 120 will automatically retrieve and present content to the user based on the user's profile. When the user is a first time visitor or his/her profile is otherwise thin, the content component 120 may automatically identify and retrieve content items relevant to the topic.

In the example of FIG. 1, the director component 124 of the filmmaking engine 118 selects a multimedia script template from the script library 126 and creates a movie-like multimedia experience (a movie) by populating with content items retrieved and customized by the content component 120. Here, each multimedia script template defines a timeline, which is a sequence of timing information for the corresponding content items to be composed as part of the multimedia content. The multimedia script template provides guidelines for the times and content items in the multimedia experience and it can be authored by administrators with experience in filmmaking. Once the script template is populated with the appropriate content, the director component 124 parses through the template to add in filmmaking techniques such as transition points tied to music track beat changes. Progression for images to achieve the desired result in the user's emotional state can also be effected in this stage.

In the example of FIG. 1, the script template can be created either in the form of a template specified by an expert in movie creation or automatically by a script generating component 122 based on one or more rules from a rules library 130. In both cases, the script generating component 122 generates a script template with content item placeholders for insertion of actual content items personalized by the content component 120, wherein the content items inserted can be images, short text quotes, music or audio, and script dialogs.

In some embodiments, for each content item, the expert-authored script template may specify the start time, end time, and duration of the content item, whether the content item is repeatable or non-repeatable, how many times it should be repeated (if repeatable) as part of the script, or what the delay should be between repeats. The table below represents an example of a multimedia script template, where there is a separate track for each type of content item in the template: Audio, Image, Text, Video, etc. There are a total of 65 seconds in this script and the time row represents the time (start=:00 seconds) that a content item starts or ends. For each content type, there is a template item (denoted by a number) that indicates a position at which a content item must be provided. In this example:

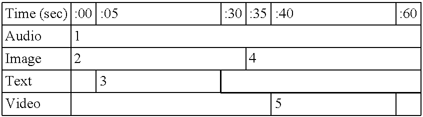

:00-:65 #1-Audio item
:00-:35 #2-Image item
:05-:30 #3-Text item
:35-:65 #4-Image item
:40-:60 #5-Video item

While this approach provides a flexible and consistent method to author multimedia script templates, the synchronization to audio requires the development of a script template for each audio item (i.e., song, wilderness sound effect) that is selected by the user for a template-based implementation.

In an alternate embodiment, the multimedia script template is created by the script generating component 122 automatically based on rules from the rules library 130. The script generating component 122 may utilize an XML format with a defined schema to design rules that include, for a non-limiting example, <Initial Music=30>, which means that the initial music clip for this script template will run 30 minutes. The advantage of rule-based script template generation is that it can be easily modified by changing a rule. The rule change can then propagate to existing templates in order to generate new templates. For rules-based auto generation of the script or for occasions when audio files are selected dynamically (e.g., a viewer uploads his or her own song), the audio files will be analyzed and synchronization will be performed by the director component 124 as discussed below.

For filmmaking, the director component 124 of the filmmaking engine 118 needs to create appropriately timed music, sound effects, and background audio. For non-limiting examples of the types of techniques that may be employed to create a high-end viewer experience, it is taken for granted that the sounds of nature will occur when the scene is in the wilderness. It is also assumed that subtle or dramatic changes in the soundtrack such as a shift in tempo or beat will be timed to a change in scenery (imagery) or dialog (text).

For both the expert-authored and the rules-generated script templates, the director component 124 of the filmmaking engine 118 enables audio-driven timeline adjustment of transitions and presentations of content items for the template. More specifically, the director component 124 dynamically synchronizes the retrieved and/or customized multimedia content items such as images or video clips with an audio clip/track to create a script of movie-like content based on audio analysis and script timeline marking, before presenting the movie-like content to the user via the display component 106 of the user interaction engine 102. First, the director component 124 analyzes the audio clip/file and identifies various audio markers in the file, wherein the markers mark the time where music transition points exist on a timeline of a script template. These markers include but are not limited to adjustment points for the following audio events: key change, dynamics change, measure change, tempo change, and beat detection. The director component 124 then synchronizes the audio markers representing music tempo and beat change in the audio clip with images/videos, image/video color, and text items retrieved and identified by the content component 120 for overlay. In some embodiments, the director component 124 may apply audio/music analysis in multiple stages, first as a programmatic modification to existing script template timelines, and second as a potential rule criterion in the rule-based approach for script template generation.

In some embodiments, the director component 124 of the filmmaking engine 118 identifies various points in a timeline of the script template, wherein the points can be adjusted based on the time or duration of a content item. For non-limiting examples, such adjustment points include but are not limited to:
Item transition time, which is a single point in time that can be moved forward or back along the timeline. The item transition time further includes:
   a. Item start time (same as the item beginning transition start time)
   b. Item beginning transition end time
   c. Item ending transition start time
   d. Item end time (same as the item ending transition end time) as shown in FIG. 6(a).
Durations, which are spans of time, either for the entire item or for a transition. A duration may further include:
   a. Item duration
   b. Item beginning transition duration
   c. Item ending transition duration
As shown in FIG. 6(b).
   Here, the adjustment points can apply to content items such as images, text, and messages that can be synchronized with an audio file.

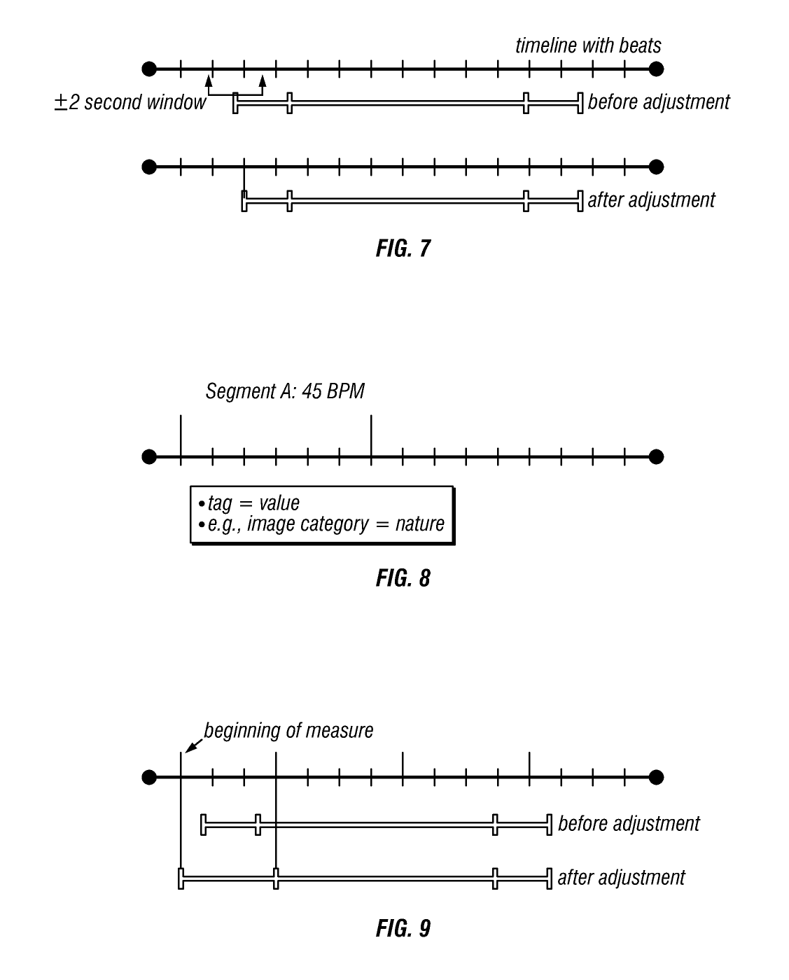

In some embodiments, the director component 124 of the filmmaking engine 118 performs beat detection to identify the point in time (time index) at which each beat occurs in an audio file. Such detection is resilient to changes in tempo in the audio file and it identifies a series of time indexes, where each time index represents, in seconds, the time at which a beat occurs. The director component 124 may then use the time indexes to modify the item transition time, within a given window, which is a parameter that can be set by the director component 124. For a non-limiting example, if a script template specifies that an image begins at time index 15.5 with a window of ±2 seconds, the director component 124 may find the closest beat to 15.5 within the range of 13.5-17.5, and adjust the start time of the image to that time index as shown in FIG. 7. The same adjustment may apply to each item transition time. If no beat is found within the window, the item transition time will not be adjusted.

In some embodiments, the director component 124 of the filmmaking engine 118 performs tempo change detection to identify discrete segments of music in the audio file based upon the tempo of the segments. For a non-limiting example, a song with one tempo throughout, with no tempo changes, will have one segment. On the other hand, a song that alternates between 45 BPM and 60 BPM will have multiple segments as shown below, where segment A occurs from 0:00 seconds to 30:00 seconds into the song, and has a tempo of 45 BPM. Segment B begins at 30:01 seconds, when the tempo changes to 60 BPM, and continues until 45:00 seconds.
A: 00:00-30:00: 45 BPM
B: 30:01-45:00: 60 BPM
C: 45:01-72:00: 45 BPM
D: 72:01-90:00: 60 BPM
   One application of tempo change detection is to perform the same function as beat detection, with a higher priority, e.g., the item transition times can be modified to occur at a time index at which a tempo change is detected, within a given window. Another application of tempo detection is for a rules-based synchronization approach where, for a non-limiting example, a rule could be defined as: when a tempo change occurs and the tempo is <N, select an image with these parameters (tags or other metadata) as shown in FIG. 8.

In some embodiments, the director component 124 of the filmmaking engine 118 performs measure detection, which attempts to extend the notion of beat detection to determine when each measure begins in the audio file. For a non-limiting example, if a piece of music is in 4/4 time, then each measure contains four beats, where the beat that occurs first in the measure is more significant than a beat that occurs intra-measure. The duration of a measure can be used to set the item transition duration. FIG. 9 shows the adjustment of the item beginning transition to coincide with the duration of a measure. A similar adjustment would occur with the ending transition.

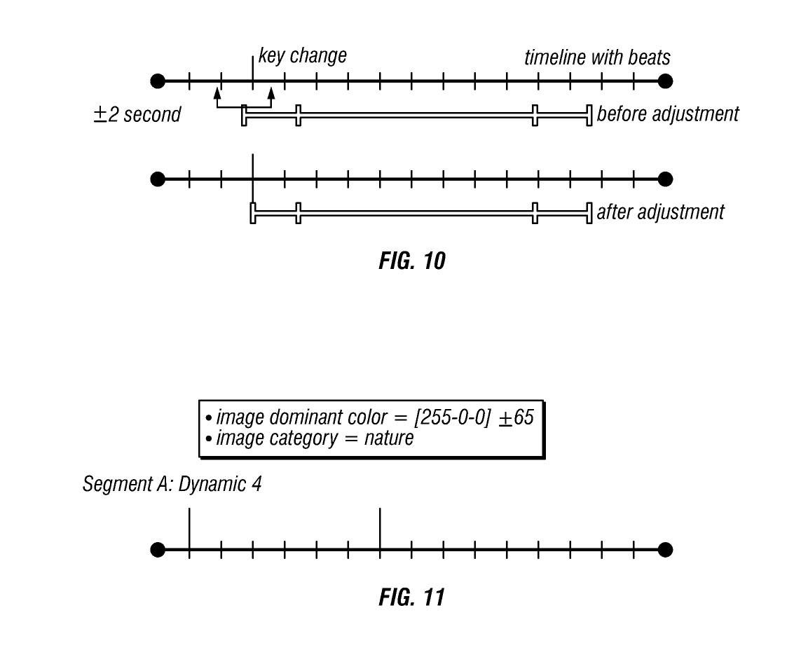

In some embodiments, the director component 124 of the filmmaking engine 118 performs key change detection to identify the time index at which a song changes key in the audio file, for a non-limiting example, from G-major to D-minor. Typically such key change may coincide with the beginning of a measure. The time index of a key change can then be used to change the item transition time as shown in FIG. 10.

In some embodiments, the director component 124 of the filmmaking engine 118 performs dynamics change detection to determine how loudly a section of music in the audio file is played. For non-limiting examples:
pianissimo—very quiet
piano—quiet
mezzo piano—moderately quiet
mezzo forte—moderately loud
forte—loud
fortissimo—very loud
   The objective of dynamics change detection is not to associate such labels with sections of music, but to detect sections of music with different dynamics, and their relative differences. For a non-limiting example, different sections in the music can be marked as:
A: 00:00-00:30: 1
B: 00:31-00:45: 3
C: 00:46-01:15: 4
D: 01:16-01:45: 2
E: 01:46-02:00: 4
   where 1 represents the quietest segments in this audio file and 4 represents the loudest. Furthermore, segment C should have the same relative loudness as section E, as they are both marked as 4. One application of dynamics change detection is similar to beat detection, where the item transition times can be adjusted to coincide with changes in dynamics within a given window. Another application of dynamics change detection is a rules-based approach, where specific item tags or other metadata can be associated with segments that have a given relative or absolute dynamic. For a non-limiting example, a rule could specify that for a segment with dynamic level 4, only images with dominant color [255-0-0] (red), ±65, and image category=nature can be selected as shown in FIG. 11.

In some embodiments, when multiple audio markers exist in the audio file, the director component 124 of the filmmaking engine 118 specifies an order of precedence for audio markers to avoid potential for conflict, as many of the audio markers described above can affect the same adjustment points. In the case where two or more markers apply in the same situation, one marker will take precedence over others according to the following schedule:
1. Key change
2. Dynamics change
3. Measure change
4. Tempo change
5. Beat detection
   Under such precedence, if both a change in measure and a change in dynamics occur within the same window, the change in dynamics will take precedence over the change in measure when the director component 124 considers a change in an adjustment point.

In some embodiments, the director component 124 of the filmmaking engine 118 adopts techniques to take advantage of encoded meta-information in images to create a quality movie experience, wherein such techniques include but are not limited to, transitioning, zooming in to a point, panning to a point (such as panning to a seashell on a beach), panning in a direction, linkages to music, sound, and other psychological cues, and font treatment to set default values for text display such as font treatments including font family, size, color, shadow, and background color for each type of text displayed. Certain images may naturally lend themselves to be zoomed into a specific point to emphasize its psychoactive tagging. For a non-limiting example, for an image that is rural, the director component 124 may slowly zoom into a still pond by a meadow. Note that the speed of movement and start-end times may be configurable or calculated by the director component 124 to ensure the timing markers for the audio track transitions are smooth and consistent.

In some embodiments, the director component 124 of the filmmaking engine 118, replicating a plurality of decisions made by a human film editor, generates and inserts one or more progressions of images from the content library 128 during creation of the movie to effectuate an emotional state-change in the user. Here, the images used for the progressions are tagged for their psychoactive properties as discussed above. Such progression of images (the “Narrative”) in quality filmmaking tells a parallel story which the viewer may or may not be consciously aware of and enhances either the plot (in fiction films) or the sequence of information (in non-fiction films or news reports). For a non-limiting example, if a movie needs to transit a user from one emotional state to another, a progression of images from a barren landscape can transition slowly to one of a lush and vibrant landscape. While some image progressions may not be this overt, subtle progressions may be desired for a wide variety of movie scenes. In some embodiments, the director component 124 of the filmmaking engine 118 also adopts techniques, which although are often subtle and not necessarily recognizable by the viewer, contribute to the overall feel of the movie and engender a view of quality and polish.

In some embodiments, the director component 124 of the filmmaking engine 118 creates a progression of images that mimics the internal workings of the psyche rather than the external workings of concrete reality. By way of a non-limiting illustration, the logic of a dream state varies from the logic of a chronological sequence since dream states may be non-linear and make intuitive associations between images while chronological sequences are explicit in their meaning and purpose. Instead of explicit designating which progression of images to employ, the director component 124 enables the user to “drive” the construction of the image progressions by identifying his/her current and desired feeling state as discussed in details below. Compared to explicit designation of a specific image progression to use, such an approach allows multiple progressions of images to be tailored specifically to the feeling-state of each user, which gives the user a unique and meaningful experience with each movie-like content.

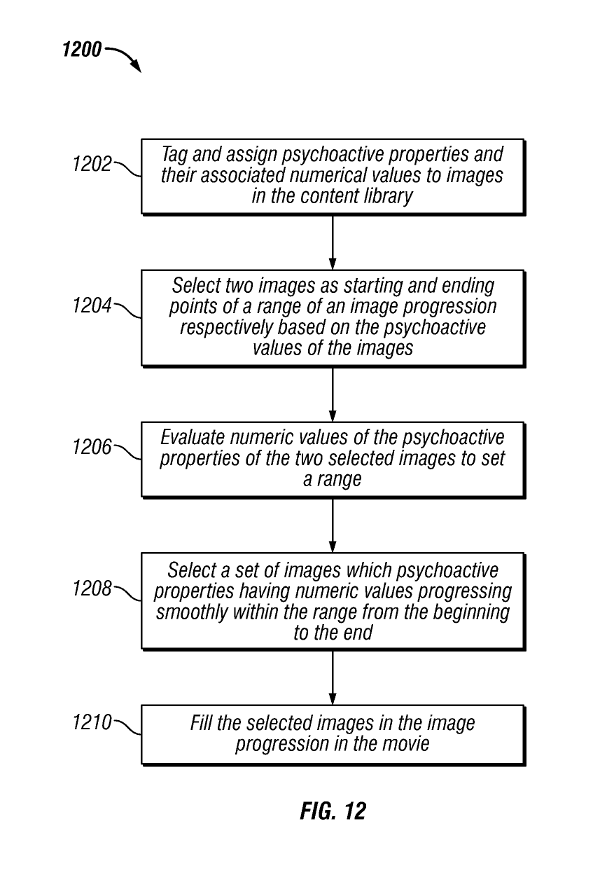

FIG. 12 depicts a flowchart of an example of a process to create an image progression in a movie based on psychoactive properties of the images. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 12, the flowchart 1200 starts at block 1202 where psychoactive properties and their associated numerical values are tagged and assigned to images in the content library 128. Such assignment can be accomplished by adjusting the sliders of psychoactive tags shown in FIG. 5. The flowchart 1200 continues to block 1204 where two images are selected by a user as starting and ending points respectively of a range for an image progression based on the psychoactive values of the images. The first (starting) image selected from a group of sample images best represents the user's current feeling/emotional state, while the second (ending) image selected from a different set of images best represents the user's desired feeling/emotional state. For a non-limiting example, a user may select a dark image that has psychoactive value of luminance of 1.2 as the starting point and a light image that has psychoactive value of luminance of 9.8 as the ending point. Other non-limiting examples of image progressions based on psycho-active tagging include from rural to urban, from ambiguous to concrete, from static to kinetic, from micro to macro, from barren-to-lush, seasons (from winter to spring), and time (from morning to late night). The flowchart 1200 continues to block 1206 where numeric values of the psychoactive properties (Ψ-tags) of the two selected images, beginning with current feeling state and ending with desired feeling state are evaluated to set a range. The flowchart 1200 continues to block 1208 where a set of images which psychoactive properties having numeric values progressing smoothly within the range from the beginning to the end are selected. Here, the images progress from one with Ψ-tags representing the user's current feeling state through a gradual progression of images whose Ψ-tags move closer and closer to the user's desired feeling state. The number of images selected for the progression may be any number larger than two but is enough to ensure that there is smooth gradation progression from the starting point to the ending point. The flowchart 1200 ends at block 1210 where the selected images are filled in the image progression in the movie.

In some embodiments, the director component 124 of the filmmaking engine 118 detects if there is a gap in the progression of images where some images with desired psychoactive properties are missing. If such a gap does exist, the director component 124 then proceeds to research, mark, and collect more images either from the content library 128 or over the internet in order to fill the gap. For a non-limiting example, if the director component 124 tries to build a progression of images that is both morning-to-night and barren-to-lush, but there are not any (or many) sunset-over-the-rainforest images, the director component 124 will detect such image gap and to include more images in the content library 128 in order to fill such gap.

In some embodiments, the director component 124 of the filmmaking engine 118 builds a vector of psychoactive values (Ψ-tags) for each image tagged along multiple psychoactive properties. Here, the Ψ-tag vector is a list of numbers served as a numeric representation of that image where each number in the vector is the value of one of the Ψ-tags of the image. The Ψ-tag vector of an image chosen by the user corresponds to the user's emotional state. For a non-limiting example, if the user is angry and selects an image with a Ψ-tag vector of [2, 8, 8.5, 2 . . . ], other images with Ψ-tag vectors of similar Ψ-tag values may also reflect his/her emotional state of anger. Once Ψ-tag vectors of two images representing the user's current state and target state are chosen, the director component 124 then determines a series of “goal” intermediate Ψ-tag vectors representing the ideal set of Ψ-tags desired in the image progression from the user's current state to the target state. Images that match these intermediate Ψ-tag vectors will correspond, for this specific user, to a smooth progression from his/her current emotional state to his/her target emotional state (e.g., from angry to peaceful).

In some embodiments, the director component 124 identifies at least two types of “significant” Ψ-tags in a Ψ-tag vector as measured by change in values during image progressions: (1) a Ψ-tag of the images changes significantly (e.g., a change in value >50%) where, e.g., the images progress from morning→noon→night, or high altitude→low altitude, etc.; (2) a Ψ-tag of the images remains constant (a change in value <10%) where, e.g., the images are all equally luminescent or equally urban, etc. If the image of the current state or the target state of the user has a value of zero for a Ψ-tag, that Ψ-tag is regarded as “not applicable to this image.” For a non-limiting example, a picture of a clock has no relevance for season (unless it is in a field of daisies). If the image that the user selected for his/her current state has a zero for one of the Ψ-tags, that Ψ-tag is left out of the vector of the image since it is not relevant for this image and thus it will not be relevant for the progression. The Ψ-tags that remain in the Ψ-tag vector are “active” (and may or may not be “significant”).

In some embodiments, the director component 124 selects the series images from the content library 128 by comparing their Ψ-tag vectors with the “goal” Ψ-tag intermediate vectors. For the selection of each image, the comparison can be based on a measure of Euclidean distance between two Ψ-tag vectors—Ψ-tag vector (p₂, p₂ . . . pₙ) of a candidate image and one of the goal Ψ-tag vectors (q₂, q₂ . . . qₙ)—in an n-dimensional vector space of multiple Ψ-tags to identify the image with the closest Ψ-tag vector along all dimensions with the goal Ψ-tag vector. The Euclidean distance between the two vectors can be calculated as:

$$\sqrt{{\sum }_{i = 1}^{n} {( {p}_{i} - {q}_{i} )}^{2}} .$$

which yields a similarity score between two Ψ-tag vectors and the candidate image having the most similar vector with the goal vector (the lowest score) is selected. If a candidate image has a value of zero for a significant Ψ-tag that image is excluded since zero means that the Ψ-tag does not apply to this image and hence this image is not applicable to this progression to which the Ψ-tag is significant. Under such an approach, no random or incongruous image is selected by the director component 124 for the Ψ-tags that are included and “active” in the progression.

Note that the director component 124 selects the images by comparing the entire Ψ-tag vectors in unison even though each of the Ψ-tags in the vectors can be evaluated individually. For a non-limiting example, an image can be evaluated for “high energy” or “low energy” independently from “high density” or “low density”. However, the association between the image and an emotional state is made based on the entire vector of Ψ-tags, not just each of the individual Ψ-tags, since “anger” is not only associated with “high energy” but also associated with values of all Ψ-tags considered in unison. Furthermore, the association between an emotional state and a Ψ-tag vector is specific to each individual user based on how he/she reacts to images, as one user's settings for Ψ-tags at his/her emotional state of peacefulness does not necessarily correspond to another user's settings for Ψ-tags at his/her emotional state of peacefulness.

While the system 100 depicted in FIG. 1 is in operation, the user interaction engine 102 enables the user to login and submit a topic or situation via the user interface 104 to have a related movie created. Alternatively, the event generation engine 108 identifies a triggering event for movie generation based a published calendar and/or the user's profile. If the user is visiting for the first time, the profile engine 112 may interview the user with a set of questions in order to establish a profile of the user that accurately reflects the user's interests or concerns. Upon receiving the topic/situation from the user interaction engine 102 or a notification of a triggering event from the event generation engine 108, the filmmaking engine 118 identifies, retrieves, and customizes content items appropriately tagged and organized in content library 128 based on the profile of the user. The filmmaking engine 118 then selects a multimedia script template from the script library 126 and creates a movie-like multimedia experience (the movie) by populating the script template with the retrieved and customized content items. The filmmaking engine 118 first analyzes an audio clip/file to identify various audio markers in the file wherein the markers mark the time where music transition points exist on the timeline of the script template. The filmmaking engine 118 then generates movie-like content by synchronizing the audio markers representing adjustment points and changes in beat, music tempo, measure, key, and dynamics in the audio clip with images/videos, image/video color, text items retrieved and customized from the filmmaking engine 118 for overlay. In making the movie, the filmmaking engine 118 adopts various techniques including transitioning, zooming in to a point, panning to a point, panning in a direction, font adjustment, and image progression. Once the movie is generated, the user interaction engine 102 presents it to the user via the display component 106 and enables the user to rate or provide feedback to the content presented.

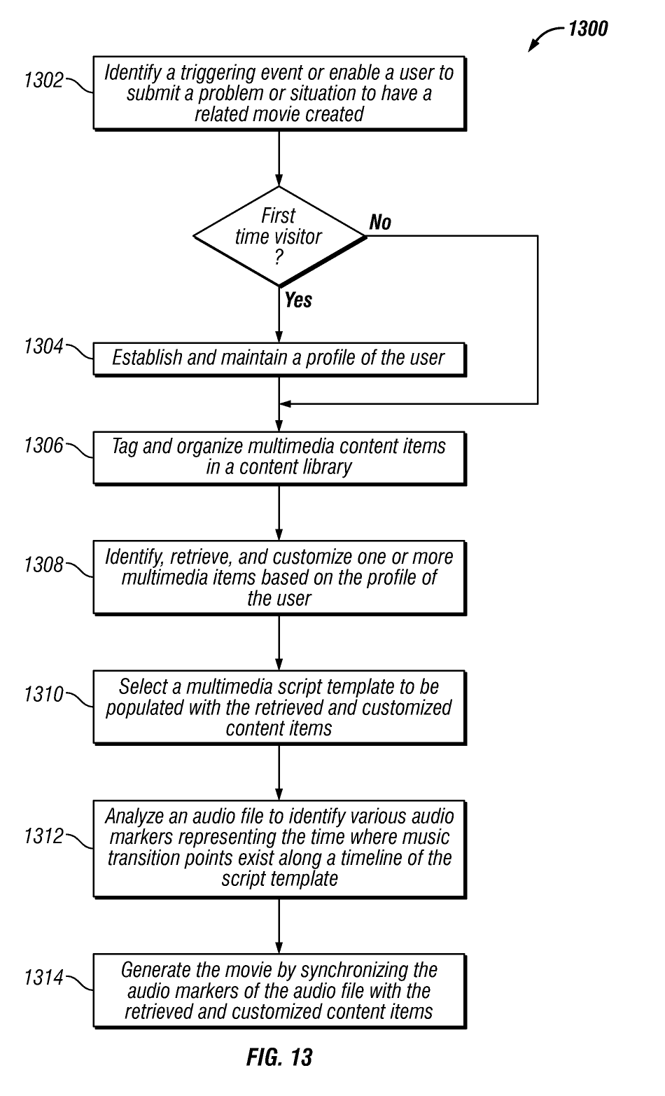

FIG. 13 depicts a flowchart of an example of a process to support algorithmic movie generation. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 13, the flowchart 1300 starts at block 1302 where a triggering event is identified or a user is enabled to submit a topic or situation to which the user intends to seek help or counseling and have a related movie created. The submission process can be done via a user interface and be standardized via a list of pre-defined topics/situations organized by categories. The flowchart 1300 continues to block 1304 where a profile of the user is established and maintained if the user is visiting for the first time or the user's current profile is otherwise thin. At least a portion of the profile can be established by initiating interview questions to the user targeted at soliciting information on his/her personal interests and/or concerns. In addition, the profile of the user can be continuously updated with the topics raised by the user and the scripts of content presented to him/her. The flowchart 1300 continues to block 1306 where a set of multimedia content items are maintained, tagged, and organized properly in a content library for easy identification, retrieval, and customization. The flowchart 1300 continues to block 1308 where one or more multimedia items are identified, retrieved, and customized based on the profile and/or current context of the user in order to create personalized content tailored for the user's current need or situation. The flowchart 1300 continues to block 1310 where a multimedia script template is selected to be populated with the retrieved and customized content items. The flowchart 1300 continues to block 1312 where an audio file is analyzed to identify various audio markers representing the time where music transition points exist along a timeline of a script template. Here, the audio markers can be identified by identifying adjustment points in the timeline, beats, tempo changes, measures, key changes, and dynamics changes in the audio file. Finally, the flowchart 1300 ends at block 1314 where the movie-like content is generated by synchronizing the audio markers of the audio file with retrieved and customized content items.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs) or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a content library, which in operation, maintains a plurality of multimedia content items as well as definitions, tags, and source of the content items;
a filmmaking engine, which in operation,
identifies, retrieves, and customizes one or more multimedia content items from the content library based on a profile of a user;
selects a multimedia script template to be populated with the retrieved and customized content items, wherein the template defines a timeline for the content items to be composed as part of a content;
analyzes an audio file to identify a plurality of audio markers representing where music transition points exist along the timeline of the script template;
generates a movie-like content comprising of the one or more identified, retrieved, and customized content items by synchronizing the one or more content items with the plurality of audio markers of the audio file.

2. The system of claim 1, wherein:
each of the one or more multimedia content items is a text, an image, an audio, a video item, or other type of content item from which the user can learn information or be emotionally impacted.

3. The system of claim 2, wherein:
the text item is used for displaying quotes, which are short extracts from a longer text or a short text.

4. The system of claim 2, wherein:
the text item is in a long format for contemplation or assuming a voice for communication with the user to explain or instruct a practice.

5. The system of claim 2, wherein:
the text item is used to create a conversational text or script dialog with the user.

6. The system of claim 2, wherein:
the audio item includes music, sound effects, or spoken word.

7. The system of claim 2, wherein:
the image item is characterized and tagged with a number of psychoactive properties for its inherent characteristics that are known, or presumed, to affect the emotional state of the user.

8. The system of claim 7, wherein:
numerical values of the psychoactive properties are assigned to a range of emotional issues to the image item as well as the user's current context and emotional state.

9. The system of claim 1, further comprising:
a user interaction engine, which in operation, performs one or more of:
enabling the user to submit a topic or situation to which the user intends to seek help or counseling;
enabling the user to submit a request for the movie-like content related to the topic or situation;
presenting the movie-like content to the user.

10. The system of claim 9, wherein:
the user interaction engine enables the user to rate or provide feedback to the content presented.

11. The system of claim 1, further comprising:
an event generation engine, which in operation, determines an event that is relevant to the user, wherein such event triggers the generation of the movie-like content.

12. The system of claim 11, wherein:
the event is determined by an alert of a news feed.

13. The system of claim 1, further comprising:
a profile engine, which in operation, establishes and maintains the profile of the user.

14. The system of claim 13, wherein:
the profile engine establishes the profile of the user by initiating one or more questions during pseudo-conversational interactions with the user for the purpose of soliciting and gathering at least part of the information for the user profile.

15. The system of claim 13, wherein:
the profile engine update the user profile with history of topics raised by the user, the content presented to the user, and feedback and ratings of the content from the user.

16. The system of claim 1, wherein:
the filmmaking engine tags and organizes each of the content items in the content library in a richly describe taxonomy with one or more tags and properties to enable intelligent and context-aware selections.

17. The system of claim 16, wherein:
the filmmaking engine tags and organizes the content items in the content library using a content management system (CMS) with meta-tags and customized vocabularies.

18. The system of claim 1, wherein:
the filmmaking engine browses and retrieves the content items by one or more of topics, types of content items, dates collected, and by certain categories.

19. The system of claim 1, wherein:
the script template is created either in the for of a template specified by an expert in movie creation or automatically based on one or more rules.

20. The system of claim 1, wherein:
the filmmaking engine specifies an order of precedence for the plurality of audio markers to avoid potential for conflict.

21. The system of claim 1, wherein:
the filmmaking engine identifies various points in the timeline of the script wherein the points can be adjusted based on the time or duration of a content item.

22. The system of claim 1, wherein:
the filmmaking engine performs beat detection to identify the point in time at which each beat occurs in the audio file.

23. The system of claim 1, wherein:
the filmmaking engine performs tempo change detection to identify discrete segments of music in the audio file based upon the tempo of the segment.

24. The system of claim 1, wherein:
the filmmaking engine performs measure detection to determine when each measure begins in the audio file.

25. The system of claim 1, wherein:
the filmmaking engine performs key change detection to identify the time at which a song changes key in the audio file.

26. The system of claim 1, wherein:
the filmmaking engine performs dynamics change detection to determine sections of music in the audio file with different dynamics.

27. The system of claim 1, wherein:
the filmmaking engine adopts one or more techniques of transitioning, zooming in to a point, panning to a point, panning in a direction, adjusting fonts to create the movie-like content.

28. The system of claim 1, wherein:
the filmmaking engine generates and inserts one or more progressions of images during creation of the movie-like content to effectuate an emotional state-change in the user.

29. The system of claim 28, wherein:
the filmmaking engine creates a progression of images that mimics the internal workings of the psyche rather than the external workings of concrete reality.

30. The system of claim 28, wherein:
the filmmaking engine enables the user to drive construction of the one or more image progressions by identifying his/her current and desired feeling state.

31. The system of claim 28, wherein:
the filmmaking engine detects if there is a gap in one of the progressions of images where some images with desired psychoactive properties are missing.

32. The system of claim 31, wherein:
the filmmaking engine proceeds to research, mark, and collect more images to fill the gap if such gap exists.

33. A computer-implemented method, comprising:
maintaining, tagging, and organizing a plurality of multimedia content items as well as definitions, tags, and source of the content items;
identifying, retrieving, and customizing one or more of the multimedia content items based on a profile of a user;
selecting a multimedia script template to be populated with the retrieved and customized content items, wherein the template defines a timeline for the content items to be composed as part of a content;
analyzing an audio file to identify a plurality of audio markers representing where music transition points exist along the timeline of the script template;
generating a movie-like content comprising of the one or more identified, retrieved, and customized content items by synchronizing the one or more content items with the plurality of audio markers of the audio file.

34. The method of claim 33, further comprising:
enabling the user to perform one or more of:
enabling the user to submit a topic or situation to which the user intends to seek help or counseling;
enabling the user to submit a request for the movie-like content related to the topic or situation;
presenting the movie-like content to the user.

35. The method of claim 33, further comprising:
enabling the user to rate or provide feedback to the content presented.

36. The method of claim 33, further comprising:
identifying an event that is relevant to the user, wherein such event triggers the generation of the movie-like content.

37. The method of claim 33, further comprising:
establishing and maintaining the profile of the user.

38. The method of claim 33, further comprising:
updating the user profile with history of topics raised by the user, the content presented to the user, and feedback and ratings of the content from the user.

39. The method of claim 33, further comprising:
characterizing and tagging an image item with a number of psychoactive properties for its inherent characteristics that are known, or presumed, to affect the emotional state of the user.

40. The method of claim 39, further comprising:
assigning numerical values of the psychoactive properties to a range of emotional issues to the image item as well as the user's current context and emotional state.

41. The method of claim 33, further comprising:
tagging and organizing each of the content items in a richly describe taxonomy with one or more tags and properties to enable intelligent and context-aware selections.

42. The method of claim 33, further comprising:
tagging and organizing the content items using a content management system (CMS) with meta-tags and customized vocabularies.

43. The method of claim 33, further comprising:
browsing and retrieving the content items by one or more of topics, types of content items, dates collected, and by certain categories.

44. The method of claim 33, further comprising:
creating the script template either in the form of a template specified by an expert in movie creation or automatically based on one or more rules.

45. The method of claim 33, further comprising:
specifying an order of precedence for the plurality of audio markers to avoid potential for conflict.

46. The method of claim 33, further comprising:
identifying various points in the timeline of the script wherein the points can be adjusted based on the time or duration of a content item.

47. The method of claim 33, further comprising:
performing beat detection to identify the point in time at which each beat occurs in the audio file.

48. The method of claim 33, further comprising:
performing tempo change detection to identify discrete segments of music in the audio file based upon the tempo of the segment.

49. The method of claim 33, further comprising:
performing measure detection to determine when each measure begins in the audio file.

50. The method of claim 33, further comprising:
performing key change detection to identify the time at which a song changes key in the audio file.

51. The method of claim 33, further comprising:
performing dynamics change detection to determine sections of music in the audio file with different dynamics.

52. The method of claim 33, further comprising:
adopting one or more techniques of transitioning, zooming in to a point, panning to a point, panning in a direction, adjusting fonts to create the movie-like content.

53. The method of claim 33, further comprising:
generating and inserting one or more progressions of images during creation of the movie-like content to effectuate an emotional state-change in the user.

54. The method of claim 53, further comprising:
creating a progression of images that mimics the internal workings of the psyche rather than the external workings of concrete reality.

55. The method of claim 53, further comprising:
enabling the user to drive construction of the one or more image progressions by identifying his/her current and desired feeling state.

56. The method of claim 53, further comprising:
detecting if there is a gap in one of the progressions of images where some images with desired psychoactive properties are missing.

57. The method of claim 56, further comprising:
proceeding to research, mark, and collect more images to fill the gap if such gap exists.

58. A machine readable medium having software instructions stored thereon that when executed cause a system to:
maintain, tag, and organize a plurality of multimedia content items as well as definitions, tags, and source of the content items;
enable the user to submit a topic to which a user intends to seek help or counseling;
establish and maintain a profile of the user;
identify, retrieve, and customize one or more of the multimedia content items based on the topic and the profile of the user;
select a multimedia script template to be populated with the retrieved and customized content items, wherein the template defines a timeline for the content items to be composed as part of a content;
analyze an audio file to identify a plurality of audio markers representing where music transition points exist along the timeline of the script template;
generate a movie-like content comprising of the one or more identified, retrieved, and customized content items by synchronizing the one or more content items with the plurality of audio markers of the audio file;
present the movie-like content to the user.
